(19) United States
(12) Patent Application Publication
(10) Pub. No.: US 2007/0167325 A1
(43) Pub. Date: Jul. 19, 2007

(54) Reversible thermochromic systems

(76) Inventor: Nathalie Leroux, Bouguenais (FR)

Correspondence Address: DICKSTEIN SHAPIRO, 1177 AVENUE OF THE AMERICAS (6TH AVENUE), NEW YORK, NY, 10036-2714, US

(21) Appl. No.: 10/588,875

(22) PCT Filed: Feb. 9, 2005
(86) PCT No.: PCT/US05/04038

§ 371 Date: Nov. 9, 2006

Related U.S. Application Data
(60) Provisional application No. 60/543,104, filed on Feb. 9, 2004.

(51) Int. Cl. C09D 11/00; B41M 5/24

(52) U.S. Cl. 503/201; 106/31.16; 106/31.2; 106/31.17; 106/31.64

(57) ABSTRACT

The present invention provides a reversible thermochromic system that is a two-component system based on an electron donating compound (color former) and an electron accepting compound (developer). A temperature increase to the melting point of the developer causes the system to change from a colorless state to a colored state and a temperature drop below the recrystallization temperature of the developer causes the system to change from the colored state to the colorless state. The thermochromic system of the present invention is applicable to various types of inks, such as a flexographic printing ink, a screen printing ink, a lithographic printing ink, and an intaglio printing ink. The invention also provides a method for preparing the thermochromic system of the present invention.

### FIELD OF THE INVENTION

The invention relates to a reversible thermochromic system which changes from colorless to color as the temperature is increased and from color to colorless as the temperature is decreased.

### BACKGROUND OF INVENTION

Thermochromic systems which change from a colorless state to colored state as the temperature increases can be used for a rewritable printing material. Based on their imaging function, thermochromic compounds can be generally divided into:
1. Systems that are both writable and erasable through heating to different temperatures or with different heat cycles;
2. Systems that require heating and cooling to write and erase; and
3. Systems that require heat and an electrical field to write and erase.

Among known systems, there are several proposals of using various kinds of bistable thermochromic compositions developed for rewritable systems. The term “bistable” used herein refers to an ability of a compound that can assume either one of the two stable states. A number of compounds have been identified that may reversibly develop color upon application of heat energy and that are bistable. Once placed into one or the other state (e.g. colorless or colored), the substance exhibits hysteresis, tending to persist in that state under ordinary ambient conditions.

Bistable thermochromic compositions, based on their mechanism and principle of operation can also be classified into the following three main categories:
(a) polymer organic crystals, which are based on crystal size variation of a low molecular organic compound dispersed in the polymer matrix and depend on thermal changes. The variation between a large single crystalline state, which is transparent and allows light transmission, and a polycrystalline state, which is turbid and causes light scattering, allows repeated switching between transparent and opaque states depending on heating to different temperatures.
(b) color-formers/developers/erasers systems which consist of three main components: a coloring agent (e.g., leuco dyes, lactone dyes, etc.), a developing/tone-reducing agent (e.g., urea, phosphoric acid, aliphatic carboxylic, phenolic compounds, etc.) and a matrix or binder resin (e.g., steroid, etc.). Reversible coloring and decoloring of the composition is achieved by exposing the system to different thermal energy levels causing the reaction (development) between coloring agent and developing/tone-reducing agent to form a colored state or the separation (tone reduction) forming a decolored state. Thus one temperature is required to change from colorless to color, and another temperature for the change of color to colorless; and
(c) smectic liquid crystal system which changes between opaque and transparent states, due to their bistability during the phase change.

U.S. Pat. No. 4,268,413 discloses a polymer-organic crystal system for use in imaging applications, temperature-measuring devices, temperature indicating devices, and smart windows for protection against solar radiation. U.S. Pat. Nos. 4,734,359; 5,158,924; 5,278,129; 5,298,476; 5,306,689; 5,521,371; 5,556,827; 5,627,126; 5,780,387; and 5,948,727, describe a polymer-organic crystal thermochromic composition which is a low molecular weight system made of a polymer/resin matrix (e.g. polyvinylacetal, polystyrene/polybutadiene copolymer, polyvinylacetate, vinylchloride/vinylacetate copolymer, etc.) and an organic low-molecular weight substance (fatty acids such as stearic acid, behenic acid, etc.) dispersed therein.

U.S. Pat. No. 5,178,669 and No. 5,274,460 disclose a leuco dye and a developing/tonereducing agent adapted to thermally interact with the dye and a suitable binder. Exposure of the system to a first thermal energy level (e.g. heating to a high temperature of 200°-350° C. for a short duration of 1-3 msec) produces a color, while exposure to a second thermal energy level (e.g. heating to a low temperature of 80°-150° C. for a longer duration of 5 msec to 2 sec) renders the system transparent.

U.S. Pat. No. 5,470,816 describes dimerized or trimerized urea developers. U.S. Pat. No. 5,432,534 discloses a thermally sensitive coloring agent such as a triphenylmethane phthalide compound, a fluoran compound, a phenothiazine compound, a leuco auramine compound or an indolinophthalide compound, and a color developer such as a phosphoric acid compound, an aliphatic carboxylic compound or a phenolic compound. U.S. Pat. No. 5,480,482 describes a reversible thermochromic pigment including a mixture of a colorless cyclic aryl lactone dye that undergoes ring opening to form a colored triaryl-methylene carboxylic acid dye, an alkaline (diaminoalkane) activator agent that effects ring opening of the dye when the mixture is heated and ring closure to the colorless lactone state when the mixture is cooled, and a low-melting solid that functions as a solvent and activator. Generally, the dye is rendered colorless through heating to temperatures of 30°-70° C., and colored through cooling to temperatures below 25° C.

U.S. Pat. No. 5,553,907 discloses a reversible thermosensitive coloring recording method, recording medium and recording apparatus for the recording method. U.S. Pat. Nos. 5,552,364 and 5,585,320 describe development of multi-color images by using a plurality of the thermochromic coloring composition layers, which are successively overlaid one on top of another, each of which being present independently from the other layers. Intermediate layers made of a resin are interposed between the coloring composition layers and prevent them from being fused and to each other. Each of the coloring composition layers forms a colored state different from one another and a decolorized state in a predetermined temperature ranges. Therefore, when heat is applied at a temperature at which all of the coloring composition layers develop their respective colored states, the recording medium forms a mixed coloring state. When heat is further applied to the same mixed coloring state at a specific decolorizing temperature that is lower than the development temperature range, the mixed colored image is decolorized or a single color image is formed.

U.S. Pat. No. 6,022,648 discloses a method of incorporating thermochromic materials into constructions producing full-color images and multiple gray levels. U.S. Pat. Nos. 5,847,786, No. 5,851,422, No. 6,052,137, No. 6,059,993 and No. 6,201,587 describe reversible imaging media obtained when a smectic liquid crystal is dispersed in a polymer matrix creating the so-called polymer dispersed liquid crystal film (PDLC film).

The known art discloses three components systems or systems which require multiple temperature ranges in order to change from color to colorless and colorless to color. Thus, there is a need for a two part thermochromic system which has a thermochromic effect from colorless to color as the temperature is increased and from color to colorless as the temperature is decreased.

### SUMMARY OF INVENTION

This invention is based, in part, on a discovery by the present inventor that the above objectives can be realized by a reversible thermochromic system which is two-component system based on an electron donating compound (color former) and an electron accepting compound (developer).

Accordingly, the present invention provides a reversible thermochromic system comprising an electron donating compound and an electron accepting compound, wherein the combination of the electron donating compound and the electron accepting compound is reversibly thermochromic.

In another aspect, the present invention provides a printing ink comprising the reversible thermochromic system of the present invention.

The present invention further provides a method for producing the reversible thermochromic system of the present invention.

Other objects and advantages of the present invention will become apparent from the following description and appended claims.

### DETAILED DESCRIPTION OF INVENTION

The invention provides reversible thermochromic systems which change from a colorless state to a colored state as the temperature is increased. The systems are two-component systems based on an electron donating dye (color former) and an electron accepting compound (developer). The system exhibits two different colored states depending on the temperature and goes from a colorless state to colored state as the temperature is increased, and the color change is reversible as the temperature is decreased.

In a preferred embodiment, suitable electron donating dyes/color formers of the present invention include, but are not limited to, leuco-dyes which are phthalide derivatives. Those which are most commonly used often belong to the spirolactone class. The protonation of a colorless or substantially colorless lactone by a weak-acid developer causes the lactone ring to open and results in a formation of a colored compound.

Particularly suitable ionochromic compounds include, but not by way of limitation, phthalide derivatives, such as 3-(2,2-bis(1-ethyl-2-methylindol-3-yl)vinyl)-3-(4-diethylaminophenyl)-phthalide; 3-(4-diethylamino-2-ethoxyphenyl)-3-(1-ethyl-2-methylindol-3-yl)-4-azaphthalide; 3,3-bis(4-diethylamino-2-ethoxyphenyl)-4-azaphthalide; and 3,3-bis(1-n-octyl-2-methyl-indol-3-yl)phthalide, It is preferred that the electron donating dye is a phthalide derivative.

The developers suitable for the present invention are electron accepting compounds that exhibit acidity high enough to develop the color of the inonochromic compound, i.e., to allow the protonation and opening of the lactone ring in a solvated state, but low enough to allow the colorless state, i.e., to allow the closure of the lactone ring upon recrystallization. In a preferred embodiment, the electron accepting compounds of the present invention have pKa values between about 4.0 and about 6.0, preferably between about 4.0 and about 5.0.

Thus, in a preferred embodiment, the electron accepting compounds of the present invention are low acidic compounds, such as long chain aliphatic carboxylic acids having at least about 11 carbons, more preferably at least about 15 carbons, and most preferably at least about 20 carbons, in their aliphatic chain. Particularly suitable electron accepting compounds include, but not by way of limitation, arachidic acid, stearic acid, pentadecanoic acid, myristic acid, tridecanoic acid and dodecanoic acid.

In their original state, it is believed that these electron accepting compounds form a micelle-like arrangement due to dimeric associations of the molecules involving two (2) hydrogen bonds between two (2) carboxyl groups and are stabilized by chain interactions via van der Waals forces between the aliphatic tails. When the system (i.e., color former and color developer) is heated above the melting point of the electron accepting compound, the micelle is destabilized and the ionic exchange between the electron donating compound (color former) and the electron accepting compound (developer) occurs, thereby giving the colored state. The preferable color formers suitable for the present invention are phthalides derivatives which exhibit a better molecular flexibility around the lactone ring than fluoran derivatives and allow, upon cooling, a molecular rearrangement of the developer leading to a deprotonation of the color former. Consequently, a stable loss in the color intensity or a stabilized colorless state ensues when the temperature is decreased.

The temperature at which the color develops is the melting point of the developer and the temperature at which the color disappears is its recrystallization temperature. At low temperatures below the recrystallization temperature, the developer is stabilized by chain interactions via van der Waals forces between the aliphatic tails and by hydrogen bonds between the oxygen and alcohol groups, and the color former returns to its colorless state. Once the melting point of the developer is reached, the aliphatic chains set the system free by breaking the dimeric associations with one another and making carboxylic acid groups available to the color former. When sufficient energy is reached, the acidic effect of the carboxylic acid can achieve the coloration of the leuco dye.

It should be noted that to allow a full development of the color, the system should be initially heated to the melting point of the color former, which is usually higher than that of the developer, to allow complete electronic interactions between the lactone form of the color former and the acidic moieties of the developer. This initial heating results in a more intense coloration of the system than without it when the system is once again cooled and then re-heated, this time, to the melting point of the developer.

The ratio of each component may vary according to the required contrast and colored change. In a preferred embodiment, weight ratios of color former to developer are between about 0.1 to about 2, preferably from about 0.2 to about 0.5.

The temperature of the color change depends on the melting temperature of the developer, and a large range of temperature can be utilized by varying the length of the chain of the aliphatic acid. In a preferred embodiment, the aliphatic portion of the aliphatic acid contains at least about eleven (11) carbons. The colorations which can be obtained depend on the electron donating dyes and their intrinsic coloration. Any range of color can be achieved. Examples of the color combinations include, but are not limited to, blue, using the 3-(4-diethylaminophenyl)-3-(1-ethyl-2-methylindol-3-yl)phthalide (Blue 502 from Yamamoto Chemical), or the 3-(2,2-bis(1-ethyl-2-methylindol-3-yl)vinyl)-3-(4-diethylaminophenyl)-phthalide (GN-169 from Yamamoto Chemical), magenta using the 3,3-bis(1-n-butyl-2-methyl-indol-3-yl)phthalide (Red 40 from Yamamoto Chemical) or the 3,3-bis(1-n-octyl-2-methyl-indol-3-yl)phthalide (Pergascript I-6B from Ciba Specialty Chemical), green using the 3,6,6′-tris(dimethylamino)-spiro[fluorene-9,3′-phthalide] (Green 118 from Yamamoto Chemical) or the 3,3-bis(4-diethylamino2-ethoxyphenyl)-4-azaphthalide (GN2 from Yamamoto Chemical), and a mixture thereof.

Upon heating, the color change can be from a colorless state to a color state or from a color to another color state when using a pigment in the mixture, or from a light shade to a darker shade of the same color when using adequate ratio of color former/color developer. For example, by using a blue pigment in the system and a magenta color former, a violet (at an increased temperature) to blue (at a decreased temperature) system can be achieved.

Thus, the reversible thermochromic system of the present invention changes states of color based on temperature. The system can change from color to colorless and vice versa, or from one color to another color and vice versa, or from a lighter shade to a darker shade of the same color and vice versa. The first change (Color A to Color B) is based on raising temperature. In the thermochromic system of the present invention, the intensity of Color B is always higher than that of Color A regardless of the color difference. The reverse change (Color B to Color A) is based on decreasing temperature, unlike previous systems which required two rises in temperature for two changes.

In a preferred embodiment the change in color state is detectable by the human eye. In another preferred embodiment, the color change is detectable by calorimetric measurement. In yet another preferred embodiment, the color change is detectable by both the human eye and colorimetric measurement.

The reversible thermochromic system of the present invention is suitable for printing ink applications including, but not limited to, flexographic printing, lithographic printing, intaglio printing, screen printing and the like. The reversible thermochromic system of the invention may be mixed with a suitable ink vehicle which will not react with either the color former or the developer of the system. The system is compatible with numerous printing ink systems. Suitable ink vehicles include, but not by way of limitation, natural polymers, such as rosin based resins, cellulose derivatives, such as carboxymethyl cellulose, hydroxyethyl cellulose, and hydroxypropyl cellulose and xanthans, and synthetic polymers, such as polyamides, polyvinyl esters, polyvinyl ethers, epoxide resins, polyesters, alkyd resins, polyacrylamide, polyvinyl alcohol, polyethylene oxide, polydimethyl acrylamide, polyvinyl pyrrolidone, polyvinyl methyl acetamide, polyurethane, polystyrene resin, styrene-(meth)acrylate ester copolymer resin, as well as a mixture of or copolymer of those listed above. One skilled in the art will know which printing ink systems are compatible with the reversible thermochromic system of the present invention.

The reversible thermochromic system of the present invention is further illustrated by the following non-limiting examples in which all parts and percentages are by weight and all temperatures are in centigrade, unless otherwise indicated.

### EXAMPLE 1

In this example, the reversible thermochromic system of the present invention, 3,3-bis(1-n-butyl-2-methyl-indol-3-yl)phthalide (Red 40 manufactured by Yamamoto Chemical; 10 parts), was combined with tridecanoic acid (20 parts). The components were mixed at room temperature. The term “room temperature” used herein refers to temperatures between about 20° C. and about 25° C. The obtained white mixture was spread between two glass plates. The two glass plates were heated just above the melting point of the tridecanoic acid (about 44° C.) and the mixture began to melt and a stable pink color appeared. When the heat was turned off and the system began to recrystallize, the pink color disappeared and the system returned to white again. Thus the effect was reversible.

### EXAMPLE 2

In a second example of the reversible thermochromic system of the present invention, combined were 3,3-bis(1-n-octyl-2-methyl-indol-3-yl)phthalide (Pergascript I-6B manufactured by Ciba Specialty Chemical; 10 parts) and dodecanoic acid (50 parts). The reversible thermochromic system was prepared by the components at room temperature. The obtained white mixture was spread between two glass plates. The two glass plates were heated just above the melting point of the color former (about 96° C.) and an intense magenta color appeared; then the system was cooled down to a temperature below the crystallization temperature of the dodecanoic acid (about 46° C.).

The magenta color disappeared and the system was white again. Then, upon heating again just above the melting point of the dodecanoic acid, the mixture began to melt and a stable magenta color appeared. When the heat was turned off and the system began to recrystallize, the color disappeared and the system was white again. Thus the effect was reversible.

### EXAMPLE 3

The properties of the color formers used in this example are set forth in Table 1 below.

TABLE 1

| Color | | | Melting | |
|---|---|---|---|---|
| former | | Developed | point | |
| name | Chemical name | color | (° C.) | Producer |
| Blue 63 | 3-(4-diethylamino- | Blue | 160 | Yamamoto |
| | 2-ethoxyphenyl)-3- | | | Chemical |
| | (1-ethyl-2-methyl- | | | |
| | indol-3-yl)-4-aza- | | | |
| | phthalide | | | |
| GN-2 | 3,3-bis(4-diethyl- | Green | 170 | Yamamoto |
| | amino2-ethoxy- | | | Chemical |
| | phenyl)-4-aza- | | | |
| | phthalide | | | |
| I-6B | 3,3-bis(1-n-octyl-2- | Magenta | 96 | Ciba |
| | methyl-indol-3-yl) | | | Specialty |
| | phthalide | | | Chemical |
| Red 40 | 3,3-bis(1-n-butyl-2- | Magenta | 158 | Yamamoto |
| | methyl-indol-3-yl) | | | Chemical |
| | phthalide | | | |
| ODB2 | 3-dibutylamino-6- | Black | 180 | Yamamoto |
| | methyl-7-anilino- | | | Chemical |
| | fluoran | | | |

The properties of the color developers used in this example are set forth in Table 2 below.

| Color Developer | Chemical Formula | Melting point in ° C. |
|---|---|---|
| Tridecanoic acid | CH₃(CH₂)₁₁COOH | 42-44 |
| Dodecanoic acid | CH₃(CH₂)₁₀COOH | 44-46 |
| Myristic acid | CH₃(CH₂)₁₂COOH | 53 |
| Stearic acid | CH₃(CH₂)₁₆COOH | 68 |

The systems were prepared by mixing the color former and the color developer together at various ratios, as indicated in Table 3, and heating the mixture up to the melting point of the color former so that a full color development could be obtained. Then, the mixture was cooled down to room temperature, more precisely to a temperature below the melting point of the color developer. Depending on the ratio of the color former/developer, the color obtained when the system is crystallised was colorless or a light color. Meanwhile, the color obtained when increasing the temperature above the melting point of the developer was a dark intense color. The thermochromic properties observed for these examples are summarized in the Table 3 below.

TABLE 3

| | | Ratio color | Color developed |
|---|---|---|---|
| | | former/ | above the melt |
| Color former | Developer | developer | of the developer |
| Red 40 | Tridecanoic acid | 0.5 | magenta |
| Red 40 | dodecanoic acid | 0.5 | magenta |
| Red 40 | myristic acid | 0.5 | magenta |
| Red 40 | stearic acid | 0.5 | magenta |
| ODB2 | Tridecanoic acid | 0.5 | colorless |
| ODB2 | dodecanoic acid | 0.5 | colorless |
| ODB2 | dodecanoic acid | 1 | colorless |
| ODB2 | dodecanoic acid | 2 | colorless |
| ODB2 | myristic acid | 0.5 | colorless |
| ODB2 | stearic acid | 0.5 | colorless |
| I-6B | Tridecanoic acid | 0.5 | magenta |
| I-6B | dodecanoic acid | 0.5 | magenta |
| I-6B | dodecanoic acid | 0.2 | magenta |
| I-6B | dodecanoic acid | 1 | magenta |
| I-6B | dodecanoic acid | 1.5 | magenta |
| I-6B | myristic acid | 0.5 | magenta |
| I-6B | stearic acid | 0.5 | magenta |
| Blue 63 | Tridecanoic acid | 0.5 | blue |
| Blue 63 | dodecanoic acid | 0.5 | blue |
| Blue 63 | myristic acid | 0.5 | blue |
| Blue 63 | stearic acid | 0.5 | blue |
| GN2 | Tridecanoic acid | 0.5 | blue |
| GN2 | dodecanoic acid | 0.5 | blue |
| GN2 | myristic acid | 0.5 | blue |
| GN2 | stearic acid | 0.5 | blue |

It is noticeable that, as previously mentioned, when the color former is a fluoran derivative, like the color former ODB2, the molecular conformation of the lactone prevents any color from being developed when melting the system, and the color state is stabilized upon recrystallization.

### EXAMPLE 4

The reversible thermochromic system of the present invention was formulated directly in a water-based ink system by first mixing 3-(4-diethylamino-2-ethoxyphenyl)-3-(1-ethyl-2-methylindol-3-yl)-4-azaphthalide (Blue 63 from Yamamoto chemical; 10 parts) and tridecanoic acid (20 parts) together at a temperature around 160° C., then cooling down the mixture to room temperature, and adding the mixture to a water-based sulfopolyester resin from Eastman Chemical (Eastek: 50 parts). The resulting ink was printed with a hand-coater to a thickness of 12 microns on a sheet of paper. The color of the dried print was a white. Once the temperature of the printed sample is increased above around 50° C., a blue color appeared, and the color disappeared after cooling the sample to room temperature. The effect was reversible.

### EXAMPLE 5

The reversible thermochromic system of the present invention was formulated directly in a polymer system by first mixing the 3,3-bis(1-n-butyl-2-methyl-indol-3-yl)phthalide (Red 40 from Yamamoto chemical; 10 parts) and dodecanoic acid (20 parts) together at a temperature around 160° C., then cooling down the mixture to room temperature and adding it to a polymeric system composed of a polyvinyl chloride polymer (Aldrich Chemical: 4 parts) dissolved in dichloromethane (56 parts). The resulting liquid ink was printed with a hand coater to a thickness of 12 microns on a sheet of paper. The color of the dried print was white. Once a the temperature of the printed sample is increased above around 50° C., a pink color appeared, and the color disappeared after cooling the sample to room temperature. The effect was reversible.

### EXAMPLE 6

The reversible thermochromic system of the present invention was formulated directly in a polymer system by first mixing the 3,3-bis(1-n-butyl-2-methyl-indol-3-yl)phthalide (Red 40 from Yamamoto chemical; 10 parts) and dodecanoic acid (20 parts) together at a temperature around 160° C., then cooling down the mixture to room temperature and adding it to a polymeric system composed by an ethyl cellulose polymer (Aldrich Chemical: 10 parts) dissolved in dichloromethane (50 parts). The resulting liquid ink was printed with a hand coater to a thickness of 12 microns on a sheet of paper. The color of the dried print was white. Once the temperature of the printed sample is increased above around 50° C., a pink color appeared, and the color disappears after cooling the sample to room temperature. The effect was reversible.

Those skilled in the art will recognize, or be able to ascertain many equivalents to the specific embodiments of the invention described herein using no more than routine experimentation. Such equivalents are intended to be encompassed by the following claims.

All publications, patents and patent applications mentioned in this specification are herein incorporated by reference in their entireties. Citation or discussion of a reference herein shall not be construed as an admission that such is prior art to the present invention.

What is claimed is:

1. A reversible thermochromic system comprising an electron donating compound and an electron accepting compound, wherein the combination of the electron donating compound and the electron accepting compound is reversibly thermochromic and a color change is detectable by the human eye, clolorimetric measurement, or both.

2. The system of claim 1, wherein the electron donating compound is a spirolactone.

3. The system of claim 2, wherein the electron donating compound is a phthalide derivative.

4. The system of claim 1, wherein the electron donating compound is selected from the group consisting of as 3-(2,2-bis(1-ethyl-2-methylindol-3-yl)vinyl)-3-(4-diethylaminophenyl)-phthalide; 3-(4-diethylamino-2-ethoxyphenyl)-3-(1-ethyl-2-methylindol-3-yl)-4-azaphthalide; 3,3-bis(4-diethylamino-2-ethoxyphenyl)-4-azaphthalide; and 3,3-bis(1-n-octyl-2-methyl-indol-3-yl)phthalide, and combinations thereof.

5. The system of claim 1, wherein the electron accepting compound comprises a long-chain aliphatic carboxylic acid having at least 11 carbons in the aliphatic chain.

6. The system of claim 5, wherein the electron accepting compound is non-branched, or non-grafted, or both.

7. The system of claim 5, wherein the electron accepting compound has a pKa value between about 4.0 and about 6.0.

8. The system of claim 5, wherein the electron accepting compound is selected from the group consisting of arachidic acid, stearic acid, pentadecanoic acid, myristic acid, tridecanoic acid, dodecanoic acid, and a mixture thereof.

9. The system of claim 1, wherein the weight ratio of the electron donating compound to the electron accepting compound is about 0.1 to about 2.

10. The system of claim 1 further comprising a pigment.

11. A printing ink comprising the reversible thermochromic system of claim 1.

12. The printing ink of claim 11, wherein the ink is a flexographic printing ink, a screen printing ink, a lithographic printing ink, or an intaglio printing ink.

13. A printing ink comprising the reversible thermochromic system of claim 10.

14. The printing ink of claim 13, wherein the ink is a flexographic printing ink, a screen printing ink, a lithographic printing ink, or an intaglio printing ink.

15. A method for preparing a reversible thermochromic system comprising combining an electron donating compound and an electron accepting compound, wherein the combination of the electron donating compound and the electron accepting compound is reversibly thermochromic.

16. The method of claim 15, wherein the system changes from a first color to a second color as the temperature of the system increases and changes from the second color to the first color as the temperature of the system decreases.

17. The method of claim 16, wherein the first color is colorless.

18. The method of claim 16, wherein the first color is a color.

19. The method of claim 16, wherein the second color is a color.

20. The method of claim 16, wherein the second color has a higher intensity than an intensity of the first color.
